(19) United States
(12) Patent Application Publication
(10) Pub. No.: US 2025/0126460 A1
(43) Pub. Date: Apr. 17, 2025

(54) METHOD AND APPARATUS FOR RELAY COMMUNICATION

(71) Applicant: Telefonaktiebolaget LM Ericsson (publ), Stockholm (SE)

(72) Inventor: Zhang ZHANG, Beijing (CN)

(21) Appl. No.: 18/726,508

(22) PCT Filed: Dec. 2, 2022
(86) PCT No.: PCT/CN2022/136222

§ 371 Date: Jul. 3, 2024

(30) Foreign Application Priority Data
Jan. 7, 2022 (WO) PCT/CN2022/070800

(51) Int. Cl. H04W 8/22; H04W 24/10; H04W 76/20

(52) U.S. Cl. CPC H04W 8/22; H04W 24/10; H04W 76/20

(57) ABSTRACT

Various embodiments of the present disclosure provide a method for relay communication. The method which may be performed by a first user equipment includes obtaining capability information about support of multi-path communication. The multi-path communication includes at least relay path communication. In accordance with an exemplary embodiment, the method further includes determining whether a cell is a multi-path capable cell or a multi-path incapable cell, and/or whether a second UE is a multi-path capable relay UE or a multi-path incapable relay UE, according to the capability information.

### FIELD OF THE INVENTION

The present disclosure generally relates to communication networks, and more specifically, to a method and apparatus for relay communication.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the evolution of wireless communication, a requirement for supporting device-to-device (D2D) communication features in various applications is proposed. An extension for the D2D work may consist of supporting vehicle-to-everything (V2X) communication, which may include any combination of direct communications among vehicles, pedestrians and infrastructure. Wireless communication networks such as fourth generation (4G)/long term evolution (LTE) and fifth generation (5G)/new radio (NR) networks may be expected to use V2X services and support communication for V2X capable user equipment (UE).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In a wireless communication network, direct unicast transmission over a sidelink (SL) between two V2X capable UEs may be needed in some applications such as platooning, cooperative driving, dynamic ride sharing, etc. For a remote UE in the network (NW), e.g., a UE that may be out of cell coverage and may not be able to connect with a network node directly, a UE-to-NW relay UE (also called U2N relay for short) may provide the functionality to support connectivity to the NW for the remote UE. In this case, uplink/downlink (UL/DL) traffics of the remote UE may be forwarded by the U2N relay. In some cases, the remote UE may communicate with another UE via one or more UE-to-UE relay UEs (also called U2U relays for short), and various traffics of the remote UE may be forwarded by the one or more U2U relays. Since multi-path communication may bring an improvement on transmission reliability and network throughput, it may be an attractive option to apply multi-path communication in V2X use cases, so that a remote UE may be connected to a network via, e.g., one direct path and at least one indirect path. However, some base stations and/or UEs (e.g., those as defined in 3rd generation partnership project (3GPP) Release 17) may not support multi-path with U2N relay. Therefore, there is a need to consider the capability of a base station and/or a UE to support multi-path with relay, particularly when there is a change of a serving cell and/or a communication path of the UE.

Various exemplary embodiments of the present disclosure propose a solution for relay communication, which may enable a UE and/or a network to consider a capability of supporting multi-path relay, especially for handling the case of cell/relay (re)selection and/or serving cell switching and/or path switching of the UE.

It can be appreciated that the “remote UE” described in this document may refer to a UE that may communicate with a relay UE e.g. via PC5/SL interface, and/or communicate with a network node e.g. via Uu interface. As an example, the remote UE may be a 5G proximity-based services (ProSe) enabled UE that may communicate with a data network (DN) via a ProSe 5G UE-to-NW relay UE. As another example, the remote UE may be a 5G ProSe enabled UE that may communicate with another UE via a ProSe 5G UE-to-UE relay UE.

It can be appreciated that the “relay UE” described in this document may refer to the “UE-to-NW relay UE” in a UE-to-NW relay scenario or the “UE-to-UE relay UE” in a UE-to-UE relay scenario. As an example, the relay UE may be a 5G ProSe enabled UE that is capable of supporting connectivity to the NW and/or other UE(s) for the remote UE.

It can be appreciated that the “UE-to-Network relay UE” described in this document may also be referred to as “UE-to-NW relay UE”, “UE-to-Network relay” and “UE-to-NW relay”. Thus, the terms “UE-to-Network relay UE”, “UE-to-NW relay UE”, “UE-to-Network relay” and “UE-to-NW relay” may be used interchangeably in this document.

It can be appreciated that a link or a radio link over which signals are transmitted between at least two UEs for D2D operation may be called in this document as the sidelink (SL). The signals transmitted between the UEs for D2D operation may be called in this document as SL signals. The terms “sidelink” and “SL” may also interchangeably be called as D2D link, V2X link, ProSe link, peer-to-peer link, PC5 link, etc. The SL signals may also interchangeably be called as V2X signals, D2D signals, ProSe signals, PC5 signals, peer-to-peer signals, etc.

According to a first aspect of the present disclosure, there is provided a method performed by a first UE (e.g., a remote UE, etc.). The method comprises: obtaining capability information about support of multi-path communication. The multi-path communication may include at least relay path communication. In accordance with an exemplary embodiment, the method further comprises: determining whether a cell is a multi-path capable cell or a multi-path incapable cell, and/or whether a second UE is a multi-path capable relay UE or a multi-path incapable relay UE, according to the capability information.

In accordance with an exemplary embodiment, a serving base station of the multi-path capable cell supports the multi-path communication, a serving base station of the multi-path incapable cell does not support the multi-path communication, a serving cell of the multi-path capable relay UE is served by a base station supporting the multi-path communication, and a serving cell of the multi-path incapable relay UE is served by a base station not supporting the multi-path communication.

In accordance with an exemplary embodiment, the capability information may indicate one or more of: one or more multi-path capable cells; one or more multi-path capable relay UEs; one or more multi-path capable base stations which support the multi-path communication; and one or more multi-path capable UEs which support the multi-path communication.

In accordance with an exemplary embodiment, the capability information may be obtained by the first UE from a network via one or more of: control signaling sent by a serving base station of the cell; control signaling sent by another base station different from the serving base station of the cell; non-access stratum (NAS) signaling sent by a core network entity; and a message sent by the serving base station of the cell, and the message may be related to a capability of the first UE.

In accordance with an exemplary embodiment, the capability information may be obtained by the first UE from one or more other UEs via PC5 signaling.

In accordance with an exemplary embodiment, the method according to the first aspect of the present disclosure may further comprise: transmitting a capability indication of the first UE and/or at least part of the capability information about the support of the multi-path communication to a network and/or another UE.

In accordance with an exemplary embodiment, the capability indication of the first UE may indicate whether the first UE supports the multi-path communication.

In accordance with an exemplary embodiment, the capability indication of the first UE and/or the at least part of the capability information about the support of the multi-path communication may be transmitted to the network via one or more of: a message towards a serving base station of the first UE, and the message may be related to a capability of the first UE; radio resource control (RRC) signaling towards the serving base station of the first UE; a measurement report of the first UE; and NAS signaling towards a core network entity.

In accordance with an exemplary embodiment, the NAS signaling may be used to request the core network entity to indicate one or more cells whose serving base stations support the multi-path communication.

In accordance with an exemplary embodiment, the method according to the first aspect of the present disclosure may further comprise: adding a first non-negative offset to a measurement result of one or more multi-path capable cells included in the measurement report of the first UE.

In accordance with an exemplary embodiment, the method according to the first aspect of the present disclosure may further comprise: adding a first negative offset to a measurement result of one or more multi-path incapable cells included in the measurement report of the first UE.

In accordance with an exemplary embodiment, the method according to the first aspect of the present disclosure may further comprise: adding a second non-negative offset to a measurement result of one or more multi-path capable relay UEs included in the measurement report of the first UE.

In accordance with an exemplary embodiment, the method according to the first aspect of the present disclosure may further comprise: adding a second negative offset to a measurement result of one or more multi-path incapable relay UEs included in the measurement report of the first UE.

In accordance with an exemplary embodiment, the capability indication of the first UE and/or the at least part of the capability information about the support of the multi-path communication may be transmitted to a serving base station of the first UE during radio access network notification area (RNA) update.

In accordance with an exemplary embodiment, the capability indication of the first UE and/or the at least part of the capability information about the support of the multi-path communication may be transmitted to a serving base station of the first UE, when the serving base station of the first UE supports the multi-path communication.

In accordance with an exemplary embodiment, the first UE may be configured to be a multi-path capable UE which supports the multi-path communication.

In accordance with an exemplary embodiment, the method according to the first aspect of the present disclosure may further comprise: prioritizing one or more multi-path capable cells among one or more candidate cells for cell (re)selection and/or path switching of the first UE.

In accordance with an exemplary embodiment, among the one or more multi-path capable cells, compared to a first multi-path capable cell not serving a multi-path capable relay UE which is a candidate relay UE for relay UE (re)selection and/or path switching of the first UE, a higher priority may be given to a second multi-path capable cell serving a multi-path capable relay UE which is also a candidate relay UE for the relay UE (re)selection and/or the path switching of the first UE.

In accordance with an exemplary embodiment, the method according to the first aspect of the present disclosure may further comprise: prioritizing one or more multi-path capable relay UEs among one or more candidate relay UEs for relay UE (re)selection and/or path switching of the first UE.

In accordance with an exemplary embodiment, among the one or more multi-path capable relay UEs, compared to a first multi-path capable relay UE served by a multi-path capable cell which is not a candidate cell for cell (re)selection and/or path switching of the first UE, a higher priority may be given to a second multi-path capable relay UE served by a multi-path capable cell which is also a candidate cell for the cell (re)selection and/or the path switching of the first UE.

In accordance with an exemplary embodiment, the method according to the first aspect of the present disclosure may further comprise: receiving multi-path configuration information from a base station supporting the multi-path communication, when the first UE establishes or resumes a connection with the base station. In this case, there may exist one or more relay UEs whose serving cell is served by the base station, and the one or more relay UEs may have link quality to the first UE equal to or higher than a threshold.

In accordance with an exemplary embodiment, the method according to the first aspect of the present disclosure may further comprise: transmitting, to the base station, link quality information related to the one or more relay UEs and/or the serving cell of the one or more relay UEs.

In accordance with an exemplary embodiment, the link quality information may include: information about a measured reference signal received power (RSRP)/reference signal received quality (RSRQ) and/or identifiers (IDs) of one or more relay UEs/cells selected by the first UE, and/or an indication on whether the one or more selected relay UEs/cells have good enough link quality.

In accordance with an exemplary embodiment, for path switching of the first UE, the multi-path capable cell may have a higher priority than the multi-path incapable cell to be selected as a target cell.

In accordance with an exemplary embodiment, for path switching of the first UE, the multi-path capable relay UE may have a higher priority than the multi-path incapable relay UE to be selected as a target relay UE.

In accordance with an exemplary embodiment, when the first UE is to switch from a first cell served by a source base station to a second cell served by a target base station supporting the multi-path communication, the method according to the first aspect of the present disclosure may further comprise: receiving, via the source base station, multi-path configuration information to be applied when served by the target base station.

According to a second aspect of the present disclosure, there is provided an apparatus which may be implemented as a first UE. The apparatus may comprise one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a first UE. The apparatus may comprise an obtaining unit and a determining unit. In accordance with some exemplary embodiments, the obtaining unit may be operable to carry out at least the obtaining step of the method according to the first aspect of the present disclosure. The determining unit may be operable to carry out at least the determining step of the method according to the first aspect of the present disclosure.

According to a fifth aspect of the present disclosure, there is provided a method performed by a second UE (e.g., a relay UE, etc.). The method comprises: obtaining capability information about support of multi-path communication. The multi-path communication may include at least relay path communication. In accordance with an exemplary embodiment, the method according to the fifth aspect of the present disclosure further comprises: determining whether a cell is a multi-path capable cell or a multi-path incapable cell, and/or whether a first UE is a multi-path capable UE or a multi-path incapable UE, according to the capability information.

In accordance with an exemplary embodiment, a serving base station of the multi-path capable cell supports the multi-path communication, a serving base station of the multi-path incapable cell does not support the multi-path communication, the multi-path capable UE supports the multi-path communication, and the multi-path incapable UE does not support the multi-path communication.

In accordance with an exemplary embodiment, the capability information may indicate one or more of: one or more multi-path capable cells; one or more multi-path capable relay UEs whose serving cells are served by base stations supporting the multi-path communication; one or more multi-path capable base stations which support the multi-path communication; and one or more multi-path capable UEs.

In accordance with an exemplary embodiment, the capability information may be obtained by the second UE from a network via one or more of: control signaling sent by a serving base station of the cell; control signaling sent by another base station different from the serving base station of the cell; NAS signaling sent by a core network entity; and a message sent by the serving base station of the cell, and the message may be related to a capability of the second UE.

In accordance with an exemplary embodiment, the capability information may be obtained by the second UE from one or more other UEs via PC5 signaling.

In accordance with an exemplary embodiment, the method according to the fifth aspect of the present disclosure may further comprise: transmitting a capability indication of the second UE and/or at least part of the capability information about the support of the multi-path communication to a network and/or another UE.

In accordance with an exemplary embodiment, the capability indication of the second UE may indicate whether the second UE supports the multi-path communication.

In accordance with an exemplary embodiment, the capability indication of the second UE and/or the at least part of the capability information about the support of the multi-path communication may be transmitted to the network via one or more of: a message towards a serving base station of the second UE, and the message may be related to a capability of the second UE; RRC signaling towards the serving base station of the second UE; a measurement report of the second UE; and NAS signaling towards a core network entity.

In accordance with an exemplary embodiment, the NAS signaling may be used to request the core network entity to indicate one or more cells whose serving base stations support the multi-path communication.

In accordance with an exemplary embodiment, the method according to the fifth aspect of the present disclosure may further comprise: adding a non-negative offset to a measurement result of one or more multi-path capable cells included in the measurement report of the second UE.

In accordance with an exemplary embodiment, the method according to the fifth aspect of the present disclosure may further comprise: adding a negative offset to a measurement result of one or more multi-path incapable cells included in the measurement report of the second UE.

In accordance with an exemplary embodiment, the capability indication of the second UE and/or the at least part of the capability information about the support of the multi-path communication may be transmitted to a serving base station of the second UE during RNA update.

In accordance with an exemplary embodiment, the capability indication of the second UE and/or the at least part of the capability information about the support of the multi-path communication may be transmitted to a serving base station of the second UE, when the serving base station of the second UE supports the multi-path communication.

In accordance with an exemplary embodiment, the second UE may be configured to be a multi-path capable UE which supports the multi-path communication.

In accordance with an exemplary embodiment, the method according to the fifth aspect of the present disclosure may further comprise: prioritizing one or more multi-path capable cells among one or more candidate cells for cell (re)selection and/or serving cell switching of the second UE.

In accordance with an exemplary embodiment, for serving cell switching of the second UE, the multi-path capable cell may have a higher priority than the multi-path incapable cell to be selected as a target cell.

According to a sixth aspect of the present disclosure, there is provided an apparatus which may be implemented as a second UE. The apparatus may comprise one or more processors and one or more memories storing computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a second UE. The apparatus may comprise an obtaining unit and a determining unit. In accordance with some exemplary embodiments, the obtaining unit may be operable to carry out at least the obtaining step of the method according to the fifth aspect of the present disclosure. The determining unit may be operable to carry out at least the determining step of the method according to the fifth aspect of the present disclosure.

According to a ninth aspect of the present disclosure, there is provided a method performed by a base station. The method comprises: determining a capability indication which indicates whether the base station supports s multi-path communication. The multi-path communication may include at least relay path communication. In accordance with an exemplary embodiment, the method further comprises: transmitting the capability indication of the base station to a UE and/or another base station and/or a core network entity.

In accordance with an exemplary embodiment, the capability indication of the base station may be transmitted to the UE via one or more of: control signaling sent by the base station; and a message related to a capability of the UE.

In accordance with an exemplary embodiment, the method according to the ninth aspect of the present disclosure may further comprise: receiving capability information about support of the multi-path communication from the core network entity and/or the UE and/or the another base station.

In accordance with an exemplary embodiment, the capability information about the support of the multi-path communication may indicate one or more of: one or more multi-path capable cells whose serving base stations support the multi-path communication; one or more multi-path capable relay UEs whose serving cells are served by base stations supporting the multi-path communication; one or more multi-path capable base stations which support the multi-path communication; and one or more multi-path capable UEs which support the multi-path communication.

In accordance with an exemplary embodiment, the capability information about the support of the multi-path communication may be received by the base station from the UE via one or more of: a message related to a capability of the UE; RRC signaling; and a measurement report of the UE.

In accordance with an exemplary embodiment, a first non-negative offset may be added by the UE to a measurement result of one or more multi-path capable cells included in the measurement report of the UE.

In accordance with an exemplary embodiment, a first negative offset may be added by the UE to a measurement result of one or more multi-path incapable cells included in the measurement report of the UE. A serving base station of a multi-path incapable cell does not support the multi-path communication.

In accordance with an exemplary embodiment, a second non-negative offset may be added by the UE to a measurement result of one or more multi-path capable relay UEs included in the measurement report of the UE.

In accordance with an exemplary embodiment, a second negative offset may be added by the UE to a measurement result of one or more multi-path incapable relay UEs included in the measurement report of the UE. A serving cell of a multi-path incapable relay UE is served by a base station not supporting the multi-path communication.

In accordance with an exemplary embodiment, the capability information about the support of the multi-path communication may be received by the base station from the UE during RNA update.

In accordance with an exemplary embodiment, the capability information about the support of the multi-path communication may be received by the base station from the UE, when the base station supports the multi-path communication.

In accordance with an exemplary embodiment, when the base station is configured to support the multi-path communication, the method according to the ninth aspect of the present disclosure may further comprise: transmitting multi-path configuration information to a multi-path capable UE, when the multi-path capable UE establishes or resumes a connection with the base station. In this case, there may exist one or more relay UEs whose serving cell is served by the base station, and the one or more relay UEs may have link quality to the multi-path capable UE equal to or higher than a threshold.

In accordance with an exemplary embodiment, the method according to the ninth aspect of the present disclosure may further comprise: receiving, from the multi-path capable UE, link quality information related to the one or more relay UEs and/or the serving cell of the one or more relay UEs.

In accordance with an exemplary embodiment, the link quality information may include: information about a measured RSRP/RSRQ and/or IDs of one or more relay UEs/cells selected by the multi-path capable UE, and/or an indication on whether the one or more selected relay UEs/cells have good enough link quality.

In accordance with an exemplary embodiment, for path switching of a multi-path capable UE, a multi-path capable cell may have a higher priority than a multi-path incapable cell to be selected as a target cell.

In accordance with an exemplary embodiment, for path switching of a multi-path capable UE, a multi-path capable relay UE may have a higher priority than a multi-path incapable relay UE to be selected as a target relay UE.

In accordance with an exemplary embodiment, the method according to the ninth aspect of the present disclosure may further comprise: prioritizing one or more multi-path capable cells among one or more candidate cells for cell (re)selection and/or path switching of a UE.

In accordance with an exemplary embodiment, among the one or more multi-path capable cells, compared to a first multi-path capable cell not serving a multi-path capable relay UE which is a candidate relay UE for relay UE (re)selection and/or path switching of the UE, a higher priority may be given to a second multi-path capable cell serving a multi-path capable relay UE which is also a candidate relay UE for the relay UE (re)selection and/or the path switching of the UE.

In accordance with an exemplary embodiment, the method according to the ninth aspect of the present disclosure may further comprise: prioritizing one or more multi-path capable relay UEs among one or more candidate relay UEs for relay UE (re)selection and/or path switching of a UE.

In accordance with an exemplary embodiment, among the one or more multi-path capable relay UEs, compared to a first multi-path capable relay UE served by a multi-path capable cell which is not a candidate cell for cell (re)selection and/or path switching of the UE, a higher priority may be given to a second multi-path capable relay UE served by a multi-path capable cell which is also a candidate cell for the cell (re)selection and/or the path switching of the UE.

In accordance with an exemplary embodiment, when a first remote UE is to switch from a first cell served by the base station to a second cell served by a target base station supporting the multi-path communication, the method according to the ninth aspect of the present disclosure may further comprise: transmitting information about path switching of the first remote UE to the target base station.

In accordance with an exemplary embodiment, the information about the path switching of the first remote UE may indicate one or more of: whether the first remote UE is a multi-path capable UE; whether the first remote UE is configured with multiple paths; configuration of each path of the first remote UE; a target cell selected for the first remote UE; and/or one or more target relay UEs selected for the first remote UE.

In accordance with an exemplary embodiment, when multiple paths are to be configured by the target base station for the first remote UE after path switching, the method according to the ninth aspect of the present disclosure may further comprise: receiving multi-path configuration information of the first remote UE from the target base station.

In accordance with an exemplary embodiment, the method according to the ninth aspect of the present disclosure may further comprise: forwarding the multi-path configuration information to the first remote UE.

In accordance with an exemplary embodiment, when a second remote UE is to switch from a third cell served by a source base station to a fourth cell served by the base station supporting the multi-path communication, the method according to the ninth aspect of the present disclosure may further comprise: receiving information about path switching of the second remote UE from the source base station.

In accordance with an exemplary embodiment, the method according to the ninth aspect of the present disclosure may further comprise: determining whether to configure multiple paths for the second remote UE after the path switching, according to the information about the path switching of the second remote UE.

In accordance with an exemplary embodiment, the information about the path switching of the second remote UE may indicate one or more of: whether the second remote UE is a multi-path capable UE; whether the second remote UE is configured with multiple paths; configuration of each path of the second remote UE; a target cell selected for the second remote UE; and/or one or more target relay UEs selected for the second remote UE.

In accordance with an exemplary embodiment, when the base station determines to configure the multiple paths for the second remote UE after the path switching, the method according to the ninth aspect of the present disclosure may further comprise: determining multi-path configuration information of the second remote UE.

In accordance with an exemplary embodiment, the method according to the ninth aspect of the present disclosure may further comprise: transmitting the multi-path configuration information to the second remote UE via the source base station.

According to a tenth aspect of the present disclosure, there is provided an apparatus which may be implemented as a base station. The apparatus may comprise one or more processors and one or more memories storing computer program codes. The one or more memories and the computer program codes may be configured to, with the one or more processors, cause the apparatus at least to perform any step of the method according to the ninth aspect of the present disclosure.

According to an eleventh aspect of the present disclosure, there is provided a computer-readable medium having computer program codes embodied thereon which, when executed on a computer, cause the computer to perform any step of the method according to the ninth aspect of the present disclosure.

According to a twelfth aspect of the present disclosure, there is provided an apparatus which may be implemented as a base station. The apparatus may comprise a determining unit and a transmitting unit. In accordance with some exemplary embodiments, the determining unit may be operable to carry out at least the determining step of the method according to the ninth aspect of the present disclosure. The transmitting unit may be operable to carry out at least the transmitting step of the method according to the ninth aspect of the present disclosure.

According to a thirteenth aspect of the present disclosure, there is provided a method performed by a core network entity (e.g., an access and mobility management function (AMF), etc.). The method comprises: receiving capability information about support of multi-path communication from one or more UEs and/or one or more base stations. The multi-path communication may include at least relay path communication. In accordance with an exemplary embodiment, the capability information may indicate one or more of: one or more multi-path capable cells whose serving base stations support the multi-path communication; one or more multi-path capable base stations which support the multi-path communication; one or more multi-path capable UEs which support the multi-path communication; and one or more multi-path capable relay UEs whose serving cells are served by base stations supporting the multi-path communication.

In accordance with an exemplary embodiment, the capability information may be received by the core network entity via one or more of: one or more capability indications indicating whether the one or more UEs and/or the one or more base stations support the multi-path communication; and NAS signaling from the one or more UEs.

In accordance with an exemplary embodiment, the NAS signaling may be used to request the core network entity to indicate one or more cells whose serving base stations support the multi-path communication.

In accordance with an exemplary embodiment, the method according to the thirteenth aspect of the present disclosure may further comprise: transmitting at least part of the capability information about the support of the multi-path communication to a base station and/or a UE.

According to a fourteenth aspect of the present disclosure, there is provided an apparatus which may be implemented as a core network entity. The apparatus may comprise one or more processors and one or more memories storing computer program codes. The one or more memories and the computer program codes may be configured to, with the one or more processors, cause the apparatus at least to perform any step of the method according to the thirteenth aspect of the present disclosure.

According to a fifteenth aspect of the present disclosure, there is provided a computer-readable medium having computer program codes embodied thereon which, when executed on a computer, cause the computer to perform any step of the method according to the thirteenth aspect of the present disclosure.

According to a sixteenth aspect of the present disclosure, there is provided an apparatus which may be implemented as a core network entity. The apparatus may comprise a receiving unit and optionally a transmitting unit. In accordance with some exemplary embodiments, the receiving unit may be operable to carry out at least the receiving step of the method according to the thirteenth aspect of the present disclosure. The transmitting unit may be operable to carry out at least the transmitting step of the method according to the thirteenth aspect of the present disclosure.

According to a seventeenth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to the ninth aspect of the present disclosure.

According to an eighteenth aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the ninth aspect of the present disclosure.

According to a nineteenth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the first or fifth aspect of the present disclosure.

According to a twentieth aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to the first or fifth aspect of the present disclosure.

According to a twenty-first aspect of the present disclosure, there is provided a method implemented in a communication system which may include a host computer, a base station and a UE. The method may comprise, at the host computer, receiving user data transmitted to the base station from the UE which may perform any step of the method according to the first or fifth aspect of the present disclosure.

According to a twenty-second aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the first or fifth aspect of the present disclosure.

According to a twenty-third aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the ninth aspect of the present disclosure.

According to a twenty-fourth aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the ninth aspect of the present disclosure.

According to various exemplary embodiments, a UE (such as a remote UE, a relay UE, etc.), a base station and/or a core network entity may obtain capability information about support of multi-path communication, so that communication path(s) may be configured for the UE properly based on the capability information. For a UE which supports multi-path with U2N relay, it may be preferable to select a cell served by a base station supporting multi-path with U2N relay to be a serving cell of the UE. Similarly, a multi-path capable relay UE may have a higher priority to be selected as a relay UE for the UE. This may facilitate multi-path configuration of the UE and can improve transmission reliability and user experience.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1A is a diagram illustrating an exemplary user plane stack for Layer-2 (L2) UE-to-Network relay UE according to an embodiment of the present disclosure;

FIG. 1B is a diagram illustrating an exemplary control plane stack for L2 UE-to-Network relay UE according to an embodiment of the present disclosure;

FIG. 2 is a diagram illustrating an exemplary cell and relay UE (re)selection procedure according to an embodiment of the present disclosure;

FIGS. 3A-3B are flowcharts illustrating various methods according to some embodiments of the present disclosure;

FIGS. 4A-4B are flowcharts illustrating various methods according to some embodiments of the present disclosure;

FIG. 5 is a block diagram illustrating an apparatus according to an embodiment of the present disclosure;

FIGS. 6A-6D are block diagrams illustrating various apparatuses according to some embodiments of the present disclosure;

FIG. 7 is a block diagram illustrating a telecommunication network connected via an intermediate network to a host computer in accordance with some embodiments of the present disclosure;

FIG. 8 is a block diagram illustrating a host computer communicating via a base station with a UE over a partially wireless connection in accordance with some embodiments of the present disclosure;

FIG. 9 is a flowchart illustrating a method implemented in a communication system, in accordance with an embodiment of the present disclosure;

FIG. 10 is a flowchart illustrating a method implemented in a communication system, in accordance with an embodiment of the present disclosure;

FIG. 11 is a flowchart illustrating a method implemented in a communication system, in accordance with an embodiment of the present disclosure; and

FIG. 12 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Wireless communication networks are widely deployed to provide various telecommunication services such as voice, video, data, messaging and broadcasts. To meet dramatically increasing network requirements on traffic capacity and data rates, one interesting option for communication technique development is to allow D2D communications to be implemented in a wireless communication network such as 4G/LTE or 5G/NR network. As used herein, D2D may be referred to in a broader sense to include communications between any types of UEs, and include V2X communications between a vehicle UE and any other type of UE. D2D and/or V2X may be a component of many existing wireless technologies when it comes to direct communication between wireless devices. D2D and/or V2X communications as an underlay to cellular networks may be proposed as an approach to take advantage of the proximity of devices.

3GPP specifies the LTE D2D technology, also known as sidelink (SL) or the PC5 interface, as part of Release 12 (Rel-12) of LTE. The target use cases were the proximity services (communication and discovery). Support of ProSe was enhanced during Rel-13 of LTE. In Rel-14, the LTE sidelink was extensively redesigned to support vehicular communications (commonly referred to as V2X or V2V). Support of LTE V2X related enhancements targeting the specific characteristics of vehicular communications was again enhanced during Rel-15. In LTE V2X only broadcast is supported over SL. From the point of view of the lowest radio layers, the LTE SL uses broadcast communication. That is, transmission from a UE targets any receiver that is in range.

In Rel-16, 3GPP introduced the SL for 5G NR. The driving use cases were vehicular communications with more stringent requirements than those typically served using the LTE SL. To meet these requirements, the NR SL is capable of broadcast, groupcast, and unicast communications. In groupcast communication, the intended receivers of a message are typically a subset of the vehicles near the transmitter, whereas in unicast communication, there is a single intended receiver.

Both the LTE SL and the NR SL can operate with and without network coverage and with varying degrees of interaction between UEs and the NW (network), including support for standalone, network-less operation.

In 3GPP Rel-17, national security and public safety (NSPS) is considered to be one important use case, which can benefit from the already developed NR SL features in Rel-16. Therefore, 3GPP may specify enhancements related to NSPS use case taking NR Rel-16 SL as a baseline. Besides, in some scenarios NSPS services need to operate with partial or without NW coverage, such as indoor firefighting, forest firefighting, earthquake rescue, sea rescue, etc., where the infrastructure is (partially) destroyed or not available, therefore, coverage extension is a crucial enabler for NSPS, for both NSPS services communicated between UEs and the cellular NW and that communicated between UEs over SL. In Rel.17, a SID on NR sidelink relay (as described in 3GPP RP-193253) was launched which aims to further explore coverage extension for sidelink-based communication, including both UE-to-NW relay for cellular coverage extension and UE-to-UE relay for sidelink coverage extension. Now the work has proceeded to normative phase and in the WID (as described in 3GPP RP-210893) only UE-to-NW relay is considered.

The concept of Layer-2 based UE-to-Network (U2N) relay is described in 3GPP technical report (TR) 23.752 V2.0.0. In accordance with an exemplary embodiment, a L2 UE-to-Network relay UE may provide forwarding functionality that can relay any type of traffic over the PC5 link. For example, the L2 UE-to-Network relay UE may provide the functionality to support connectivity to the 5G system (5GS) for remote UEs. A UE may be considered to be a remote UE if it has successfully established a PC5 link to the L2 UE-to-Network relay UE. The remote UE may be located within next generation-radio access network (NG-RAN) coverage or outside of NG-RAN coverage.

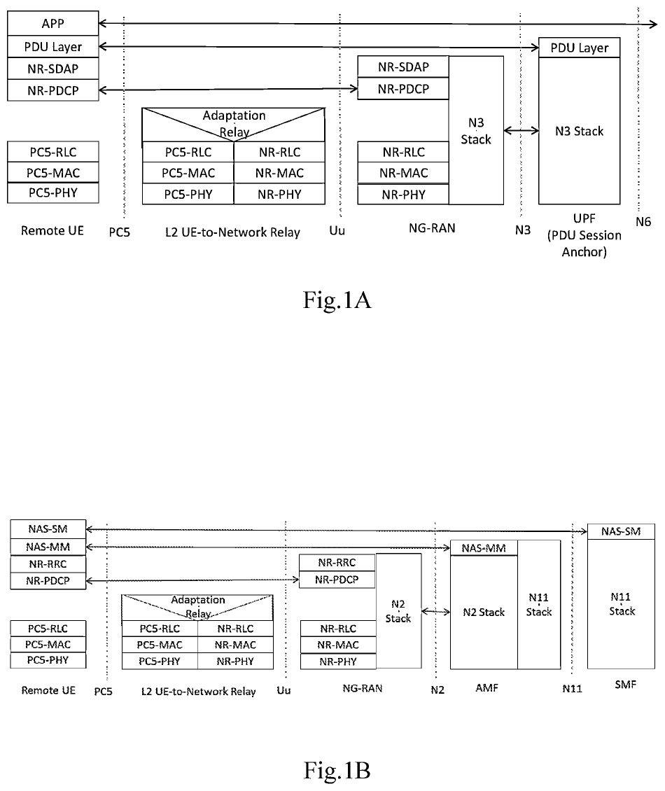

FIG. 1A is a diagram illustrating an exemplary user plane stack for L2 UE-to-Network relay UE according to an embodiment of the present disclosure. The protocol stack for the user plane transport may be related to a protocol data unit (PDU) session, including a L2 UE-to-Network relay UE. The PDU layer corresponds to the PDU carried between the remote UE and the data network (DN) over the PDU session. The two endpoints of the packet data convergence protocol (PDCP) link are the remote UE and a gNB in the network. The relay function may be performed below the PDCP layer. This means that data security may be ensured between the remote UE and the gNB without exposing raw data at the UE-to-Network relay UE. The adaptation relay layer within the UE-to-Network relay UE can differentiate between signaling radio bearers (SRBs) and data radio bearers (DRBs) for a particular remote UE. The adaption relay layer may also be responsible for mapping PC5 traffic to one or more DRBs of the Uu interface.

FIG. 1B is a diagram illustrating an exemplary control plane stack for L2 UE-to-Network relay UE according to an embodiment of the present disclosure. The role of the UE-to-Network Relay UE may be to relay the PDUs from the signaling radio bearer without any modifications. The protocol stack as shown in FIG. 1B may be applicable to the non-access stratum (NAS) connection for the remote UE to the non-access stratum-mobility management (NAS-MM) and non-access stratum-session management (NAS-SM) components. The NAS messages may be transparently transferred between the remote UE and 5G access network (5G-AN) over the L2 UE-to-Network relay UE using:
PDCP end-to-end connection where the role of the UE-to-Network relay UE is to relay the PDUs over the signaling radio bear without any modifications.
N2 connection between the 5G-AN and access and mobility management function (AMF) over N2.
N3 connection AMF and session management function (SMF) over N11.

In Rel-18, a new work item may be started to specify solutions that are needed to enhance NR SL relay for the V2X, public safety and commercial use cases. Specifically, support of multi-path with U2N relay, where a remote UE may be connected to a network via one direct path and one indirect path, has a potential to improve the reliability/robustness as well as throughput. Only the intra-gNB scenario may be considered in Rel-18.

Obviously, in order to implement such feature, a new capability may be needed at both network side and remote UE side (potentially also relay UE side). In practice, there may exist some gNB(s) and/or remote UE(s) that may not support multi-path with U2N relay (e.g., the Rel-17 gNB and/or Rel-17 remote UE). Therefore, it may be desirable to develop corresponding solutions to address improvements for the scenario where there may be both gNBs/remote UEs supporting multi-path with U2N relay and gNBs/remote UEs not supporting multi-path with U2N relay.

Various exemplary embodiments of the present disclosure propose solutions for cell/relay (re)selection and path switching where gNBs and/or remote UEs may or may not support multi-path with U2N relay. According to the proposed solutions, a UE may know whether a cell is served by a gNB supporting multi-path with U2N relay, e.g., via signaling from a gNB and/or an AMF. A relay UE may indicate over PC5 that it is served by a cell whose serving gNB supports multi-path with U2N relay. A UE supporting multi-path with U2N relay may indicate such capability to a network (e.g., to a gNB and/or an AMF) and/or to other UEs over PC5. For UEs supporting multi-path with U2N relay, one or more cells served by gNBs supporting multi-path with U2N relay may be prioritized during cell (re)selection and/or serving cell switching. For remote UEs supporting multi-path with U2N relay, one or more relay UEs served by a cell whose serving gNB supports multi-path with U2N relay may be prioritized during relay UE (re)selection and/or path switching. In addition, multi-path communication may be configured for a remote UE supporting multi-path with U2N relay during RRC connection establishment/resuming and/or path switching.

Many advantages may be achieved by applying the proposed solutions. For example, a remote UE supporting multi-path with U2N relay may be more likely to connect to a cell served by a gNB supporting multi-path with U2N relay (either directly and/or via a relay UE). In addition, the remote UE can enjoy multi-path communication right after RRC connection establishment/resuming and/or path switching. This exploits more the benefits from introducing multi-path with U2N relay and the system performance can be improved.

It can be appreciated that although some exemplary embodiments are described in the context of NR radio access technology (RAT), various embodiments described in the present disclosure may be in general applicable to any kind of direct communications between UEs involving D2D communications such as LTE SL. Embodiments are described from a transmitter (TX) UE and receiver (RX) UE point of view. Further, it is assumed that a SL UE and its serving gNB (if the UE is in NW coverage) operates with the same RAT e.g., NR, LTE, etc. However, various embodiments described in the present disclosure may also be applicable to any combination of RATs between the SL UE and its serving gNB without any loss of meaning.

Various embodiments described in the present disclosure may be applicable to L2 based U2N relay scenarios. The term “UE-to-NW relay UE” may also be denoted as “relay UE” in various embodiments. It can be appreciated that the connection between a remote UE and a relay UE may not be limited to sidelink. Any short-range communication technology such as wireless fidelity (WiFi) may also be equally applicable.

In a first embodiment, a UE (which may be a remote UE and/or a relay UE) may obtain information on whether a concerned cell is served by a gNB supporting multi-path with U2N relay via any one or more of the following ways:
From the common control signaling (e.g., a system information block (SIB), etc.) and/or dedicated control signaling sent by a gNB serving the concerned cell. In an embodiment, the signaling may include a field indicating that the gNB supports multi-path with U2N relay.
From the common control signaling (e.g. a SIB, etc.) and/or dedicated control signaling sent by a gNB serving a cell other than the concerned cell. In an embodiment, the signaling may include a field indicating that the concerned cell is served by a gNB supporting multi-path with U2N relay, where the concerned cell may be represented by a cell identifier (ID) or an area ID including the concerned cell.
From the NAS signaling sent by a core network entity (e.g., an AMF, etc.). In an embodiment, the NAS signaling may include a field indicating a set of cells whose serving gNB supports multi-path with U2N relay. The set of cells may be represented by cell IDs. The NAS signaling may be sent to the UE during initial attachment, registration area update, RRC connection establishment, etc. In another embodiment, the UE may send an explicit request to the core network entity (which may be implemented by including a field in the existing NAS signaling sent to the core network entity) to request indicating the set of cells whose serving gNB supports multi-path with U2N relay.
From a UECapabilityEnquiry message sent by a serving gNB which requests the UE to report whether the UE supports multi-path with U2N relay. In this way, the UE may implicitly know that the gNB supports multi-path with U2N relay. This option may be more suitable when the UE in RRC connected state.

In a second embodiment, a relay UE may forward over PC5 the common control signaling which may contain information about support of multi-path with U2N relay. In addition, a remote UE and/or a relay UE may indicate in PC5-S (e.g. discovery)/PC5-RRC message that it supports multi-path with U2N relay and/or it is served by a cell whose serving gNB supports multi-path with U2N relay (the remote UE may be served by the cell either directly or via a relay UE).

It can be appreciated that the UE may store the information about support of multi-path with U2N relay obtained from the network and/or another UE in its memory for later use (e.g., during cell/relay (re)selection and/or path switching, etc.).

In a third embodiment, a UE supporting multi-path with U2N relay may indicate such capability to the network via one or more of the following ways:
Informing the capability to its current serving gNB (e.g., in UECapabilityInformation, RRCSetupRequest or RRCResumeRequest, etc.). This option may be more suitable when the UE in RRC connected state or is entering RRC connected state.
Indicating, in a measurement report of the UE, the cell(s) and/or the relay UE(s) served by the gNB supporting multi-path with U2N relay. In this way, the network may implicitly know that the reporting UE also supports multi-path with U2N relay. This option may be more suitable when the UE in RRC connected state.
Informing the capability to its serving gNB only during RNA update. This option may be more suitable when the UE in RRC inactive state. In the case that the UE resumes its RRC connection with a different gNB, the gNB may fetch the UE's capability from the last serving gNB to which the UE has reported its capability.
Informing the capability to a core network entity such as AMF. The capability may be sent to the core network entity during initial attachment, registration area update, RRC connection establishment, etc. This option can be applied when the UE in RRC idle state. The capability may be sent implicitly by requesting the core network entity to indicate a set of cells whose serving gNB supports multi-path with U2N relay. In the case that the UE enters RRC connected state, its serving gNB may fetch the UE's capability from the core network entity, or be pushed with the UE's capability by the core network entity.

In accordance with an exemplary embodiment, the UE may only inform the capability to a serving gNB when the serving gNB supports multi-path with U2N relay (e.g., the UE may know this according to methods described in the first embodiment).

It can be appreciated that the network (e.g., a gNB, an AMF, etc.) may store the reported information about support of multi-path with U2N relay in its memory for later use (e.g., during cell/relay (re)selection and/or path switching, etc.).

In a fourth embodiment, a remote UE and/or a relay UE supporting multi-path with U2N relay may prioritize one or more cells served by a gNB supporting multi-path with U2N relay (such cells may be denoted as multi-path capable cells, or capable cells for short) during cell (re)selection. For instance, an absolute priority may be given to the capable cells. In accordance with an exemplary embodiment, if there exist capable cells (e.g., the UE may know this according to methods described in the first embodiment) that fulfill a criterion to be a candidate cell (e.g., with good enough measured cell RX level such as reference signal received power (RSRP) and/or measured cell quality such as reference signal received quality (RSRQ), etc.), the UE may only select a suitable cell, e.g. the highest ranked cell according to a cell reselection criterion (e.g., the cell with the best measured cell RX level (e.g., RSRP, etc.) minus a configured offset), from those capable cells.

In a fifth embodiment, a remote UE supporting multi-path with U2N relay (such remote UE may be denoted as multi-path capable remote UE, or capable remote UE for short) may prioritize relay UE(s) whose serving cell is served by a gNB supporting multi-path with U2N relay (such relay UE may be denoted as multi-path capable relay UE, or capable relay UE for short) during relay UE (re)selection. For instance, an absolute priority may be given to the capable relay UE(s). In accordance with an exemplary embodiment, if there exist capable relay UEs (e.g., the capable remote UE may know this according to methods described in the second embodiment) that fulfill a criterion to be a suitable candidate relay UE (e.g., the measured PC5 link quality is higher than a (pre) configured threshold, etc.), the capable remote UE may only select a relay UE from those capable relay UEs, potentially the relay UE with the best measured PC5 link quality.

In accordance with an exemplary embodiment, if there exist capable cells that fulfill the criterion to be a suitable candidate cell, and the capable cells serving relay UEs that fulfill the criterion to be a suitable candidate relay UE, the capable remote UE may give the highest priority to (e.g., (re) select first) such capable cells or the candidate relay UEs served by the capable cells. The capable remote UE may either select a relay UE out of those candidate relay UEs or a cell out of those capable cells.

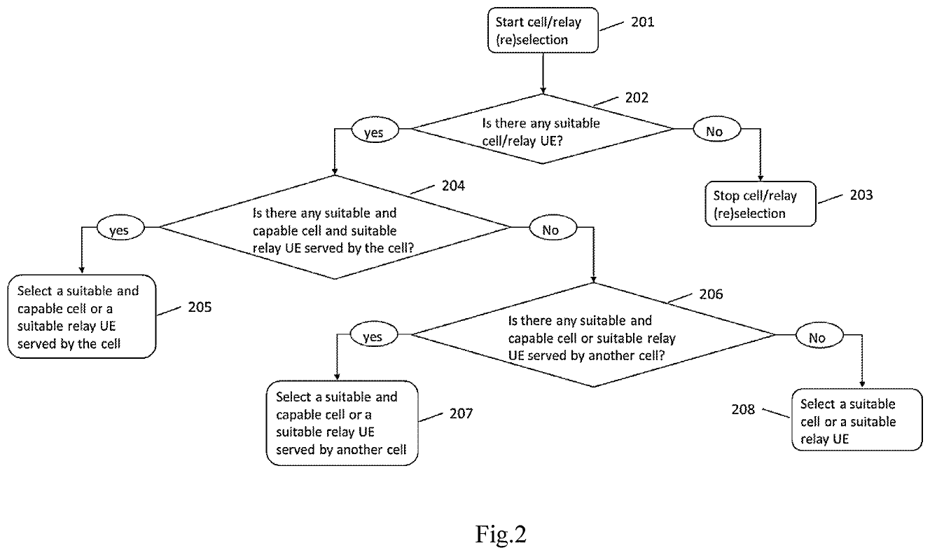

FIG. 2 is a diagram illustrating an exemplary cell and relay UE (re)selection procedure according to an embodiment of the present disclosure. The capability of supporting multi-path with U2N relay may be considered in the cell and relay UE (re)selection procedure. As shown in FIG. 2, when starting cell/relay (re)selection for a UE in step 201, it may be needed to determine whether there exists any suitable cell/relay UE, as shown in step 202. If there is no suitable cell/relay UE, the cell/relay (re)selection procedure may stop in step 203: otherwise, it may be needed to determine whether there exists any suitable and capable cell and suitable relay UE served by the cell, as shown in step 204. If there are one or more suitable and capable cells and one or more suitable relay UEs served by the cell(s), a suitable and capable cell or a suitable relay UE served by the cell may be selected in step 205. If no, it may be needed to determine whether there exists any suitable and capable cell or suitable relay UE served by another cell, as shown in step 206. If there are one or more suitable and capable cells or one or more suitable relay UEs served by another cell, a suitable and capable cell or a suitable relay UE served by another cell may be selected in step 207; otherwise, a suitable cell or a suitable relay UE may be selected in step 208.

In a sixth embodiment, when a capable remote UE establishes/resumes RRC connection in a capable cell where there exist one or more relay UEs served by the cell and with sufficient PC5 link quality to the remote UE, a gNB may configure multiple paths (where at least one path may be the relay path) for the capable remote UE during connection establishment/resuming, in which case the gNB may send access stratum (AS) configurations of all the configured paths, e.g., via the path where the capable remote UE sends RRCSetupRequest or RRCResumeRequest message. In an embodiment, all the configurations may be sent in one RRC message. By this the capable remote UE can enjoy multi-path communication right after establishing/resuming the RRC connection. In another embodiment, the remote UE may inform the Uu link quality of the cell and/or the PC5 link quality of the relay UE(s) served by the cell to the gNB, which may be considered by the gNB in determining whether or not to configure multiple paths for the remote UE.

In a seventh embodiment, during serving cell switching of a capable relay UE and/or path switching of a capable remote UE, a higher priority may be given to capable cell(s). To implement this, a serving gNB of a UE may need to know whether or not the UE is a capable UE (e.g., the gNB may know this according to methods described in the third embodiment). In addition, the gNB may need to know whether or not the neighbor cell(s) are capable cells, which may be obtained from the (neighboring) gNB(s) serving the neighbor cell(s) using Xn signaling (if needed) or from the core network using NG-AP signaling. Alternatively or additionally, the UE may indicate in the measurement report which cell(s) are capable cell(s) by e.g. associating each reported cell with one bit indicator where “1” (or “0”) means the cell is a capable cell.

Similarly, a higher priority may be given to capable relay UE(s) during path switching of a capable remote UE. To implement this, a serving gNB of a remote UE may need to know whether or not the remote UE is a capable UE (e.g., the gNB may know this according to methods described in the third embodiment). In addition, the gNB may need to know whether or not the relay UE(s) included in the measurement report are capable relay UE(s). This information may be obtained by checking whether the gNB(s) serving the relay UE(s) support multi-path with U2N relay using Xn signaling or via the core network using NG-AP signaling. Alternatively or additionally, as described in the third embodiment, the remote UE may indicate in the measurement report which relay UE(s) are capable relay UE(s) by e.g. associating each reported relay UE with one bit indicator where “1” (or “0”) means the relay UE is a capable relay UE.

In an eighth embodiment, during cell (re)selection and/or serving cell switching and/or path switching, a relay UE or a remote UE may add a non-negative offset to the Uu measurement result of capable cells and/or add a negative offset to the Uu measurement result of incapable cells, by this the capable cells may be more likely to be selected. The offsets may be configured by the network, preconfigured or hardcoded in the specification.

Similarly, during relay UE (re)selection and/or path switching, a remote UE may add a non-negative offset to the PC5 measurement result of capable relay UEs and/or add a negative offset to PC5 measurement result of incapable relay UEs, by this the capable relay UEs may be more likely to be selected. The offsets may be configured by the network, preconfigured or hardcoded in the specification.

In a ninth embodiment, during path switching of a capable remote UE, the highest priority may be given to a capable cell where there exist one or more relay UEs that are served by the cell and have good enough PC5 link quality to the remote UE. Such prioritization may only be performed when the remote UE is currently configured with multiple paths (while at least one path is a relay path). In the case that such cell and relay UE(s) can be found and it is determined to switch the remote UE to the cell, the source serving gNB of the remote UE may inform the target serving gNB (if they are different gNBs) one or more of the following information in e.g. the path switching request message:
Whether the remote UE is a capable UE;
Whether the remote UE is configured with multiple paths, and/or the configurations of each path; and
The selected target cell and/or the selected target relay UE(s).

Based on such information, the target serving gNB may determine whether multiple paths (while at least one path is a relay path via one of the target relay UE(s)) need to be configured for the remote UE after the path switching. If that is the case, the target serving gNB may prepare the paths and inform the configurations of the paths to the source serving gNB (if they are different gNBs) in e.g. the path switching response message. Then the source serving gNB may inform the configurations of the paths to the remote UE in e.g. the RRCReconfiguration message. Thus, the remote UE can enjoy multi-path communication right after the path switching.

It is noted that some embodiments of the present disclosure are mainly described in relation to 4G/LTE or 5G/NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

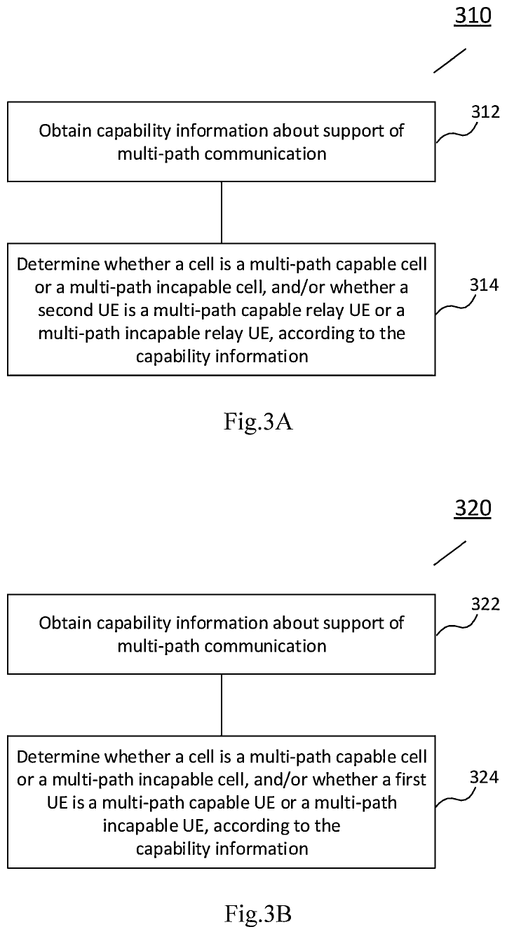

FIG. 3A is a flowchart illustrating a method 310 according to some embodiments of the present disclosure. The method 310 illustrated in FIG. 3A may be performed by a first UE (e.g., a remote UE, etc.) or an apparatus communicatively coupled to the first UE. In accordance with an exemplary embodiment, the first UE may be configured to support D2D communication (e.g., V2X or SL communication, etc.) with other devices. In an exemplary embodiment, the first UE may be configured to communicate with a network node (e.g., a base station such as gNB, etc.) directly or via a relay (e.g., a UE-to-NW relay, etc.).

According to the exemplary method 310 illustrated in FIG. 3A, the first UE may obtain capability information about support of multi-path communication, as shown in block 312. The multi-path communication may include at least relay path communication. According to the capability information, the first UE may determine whether a cell is a multi-path capable cell or a multi-path incapable cell, and/or whether a second UE is a multi-path capable relay UE or a multi-path incapable relay UE, as shown in block 314. In accordance with an exemplary embodiment, a serving base station of the multi-path capable cell supports the multi-path communication, a serving base station of the multi-path incapable cell does not support the multi-path communication, a serving cell of the multi-path capable relay UE is served by a base station supporting the multi-path communication, and a serving cell of the multi-path incapable relay UE is served by a base station not supporting the multi-path communication.

In accordance with an exemplary embodiment, the capability information may indicate one or more of: one or more multi-path capable cells; one or more multi-path capable relay UEs; one or more multi-path capable base stations which support the multi-path communication; and one or more multi-path capable UEs which support the multi-path communication.

In accordance with an exemplary embodiment, the capability information may be obtained by the first UE from a network via one or more of: control signaling sent by a serving base station of the cell; control signaling sent by another base station different from the serving base station of the cell; NAS signaling sent by a core network entity; and a message sent by the serving base station of the cell, and the message may be related to a capability of the first UE.

In accordance with an exemplary embodiment, the capability information may be obtained by the first UE from one or more other UEs via PC5 signaling (e.g., PC5-S/PC5-RRC message, etc.).

In accordance with an exemplary embodiment, the first UE may transmit a capability indication of the first UE and/or at least part of the capability information about the support of the multi-path communication to a network and/or another UE. In an embodiment, the capability indication of the first UE may indicate whether the first UE supports the multi-path communication.

In accordance with an exemplary embodiment, the capability indication of the first UE and/or the at least part of the capability information about the support of the multi-path communication may be transmitted to the network via one or more of: a message towards a serving base station of the first UE, and the message may be related to a capability of the first UE; RRC signaling towards the serving base station of the first UE; a measurement report of the first UE; and NAS signaling towards a core network entity. In an embodiment, the NAS signaling may be used to request the core network entity to indicate one or more cells whose serving base stations support the multi-path communication.

In accordance with an exemplary embodiment, the first UE may add a first non-negative offset to a measurement result of one or more multi-path capable cells included in the measurement report of the first UE. Alternatively or additionally, the first UE may add a first negative offset to a measurement result of one or more multi-path incapable cells included in the measurement report of the first UE.

In accordance with an exemplary embodiment, the first UE may add a second non-negative offset to a measurement result of one or more multi-path capable relay UEs included in the measurement report of the first UE. Alternatively or additionally, the first UE may add a second negative offset to a measurement result of one or more multi-path incapable relay UEs included in the measurement report of the first UE.

In accordance with an exemplary embodiment, the capability indication of the first UE and/or the at least part of the capability information about the support of the multi-path communication may be transmitted to a serving base station of the first UE during RNA update.

In accordance with an exemplary embodiment, the capability indication of the first UE and/or the at least part of the capability information about the support of the multi-path communication may be transmitted to a serving base station of the first UE, when the serving base station of the first UE supports the multi-path communication.

In accordance with an exemplary embodiment, the first UE may be configured to be a multi-path capable UE which supports the multi-path communication.

In accordance with an exemplary embodiment, the first UE may prioritize one or more multi-path capable cells among one or more candidate cells for cell (re)selection and/or path switching of the first UE. In an embodiment, among the one or more multi-path capable cells, compared to a first multi-path capable cell not serving a multi-path capable relay UE which is a candidate relay UE for relay UE (re)selection and/or path switching of the first UE, a higher priority may be given to a second multi-path capable cell serving a multi-path capable relay UE which is also a candidate relay UE for the relay UE (re)selection and/or the path switching of the first UE.

In accordance with an exemplary embodiment, the first UE may prioritize one or more multi-path capable relay UEs among one or more candidate relay UEs for relay UE (re)selection and/or path switching of the first UE. In an embodiment, among the one or more multi-path capable relay UEs, compared to a first multi-path capable relay UE served by a multi-path capable cell which is not a candidate cell for cell (re)selection and/or path switching of the first UE, a higher priority may be given to a second multi-path capable relay UE served by a multi-path capable cell which is also a candidate cell for the cell (re)selection and/or the path switching of the first UE.

In accordance with an exemplary embodiment, the first UE may receive multi-path configuration information from a base station supporting the multi-path communication, when the first UE establishes or resumes a connection with the base station. In this case, there may exist one or more relay UEs whose serving cell is served by the base station, and the one or more relay UEs may have link quality to the first UE equal to or higher than a threshold.

In accordance with an exemplary embodiment, the first UE may transmit to the base station, link quality information related to the one or more relay UEs and/or the serving cell of the one or more relay UEs. In an embodiment, the link quality information may include: information about a measured RSRP/RSRQ and/or IDs of one or more relay UEs/cells selected by the first UE, and/or an indication on whether the one or more selected relay UEs/cells have good enough link quality.

In accordance with an exemplary embodiment, for path switching of the first UE, the multi-path capable cell may have a higher priority than the multi-path incapable cell to be selected as a target cell. In accordance with another exemplary embodiment, for path switching of the first UE, the multi-path capable relay UE may have a higher priority than the multi-path incapable relay UE to be selected as a target relay UE.

In accordance with an exemplary embodiment, when the first UE is to switch from a first cell served by a source base station to a second cell served by a target base station supporting the multi-path communication, the first UE may receive, via the source base station, multi-path configuration information to be applied when served by the target base station.

FIG. 3B is a flowchart illustrating a method 320 according to some embodiments of the present disclosure. The method 320 illustrated in FIG. 3B may be performed by a second UE (e.g., a relay UE, etc.) or an apparatus communicatively coupled to the second UE. In accordance with an exemplary embodiment, the second UE may be configured to support D2D communication (e.g., V2X or SL communication, etc.) with other devices. In an exemplary embodiment, the second UE may be configured to communicate with a network node (e.g., a base station such as gNB, etc.) directly or via a relay (e.g., a UE-to-NW relay, etc.). In another exemplary embodiment, the second UE may be configured to act as a relay UE for one or more other UEs.

According to the exemplary method 320 illustrated in FIG. 3B, the second UE may obtain capability information about support of multi-path communication, as shown in block 322. The multi-path communication may include at least relay path communication. According to the capability information, the second UE may determine whether a cell is a multi-path capable cell or a multi-path incapable cell, and/or whether a first UE is a multi-path capable UE or a multi-path incapable UE, as shown in block 324. In accordance with an exemplary embodiment, a serving base station of the multi-path capable cell supports the multi-path communication, a serving base station of the multi-path incapable cell does not support the multi-path communication, the multi-path capable UE supports the multi-path communication, and the multi-path incapable UE does not support the multi-path communication.

In accordance with an exemplary embodiment, the capability information may indicate one or more of: one or more multi-path capable cells; one or more multi-path capable relay UEs whose serving cells are served by base stations supporting the multi-path communication; one or more multi-path capable base stations which support the multi-path communication; and one or more multi-path capable UEs.

In accordance with an exemplary embodiment, the capability information may be obtained by the second UE from a network via one or more of: control signaling sent by a serving base station of the cell; control signaling sent by another base station different from the serving base station of the cell; NAS signaling sent by a core network entity; and a message sent by the serving base station of the cell, and the message may be related to a capability of the second UE. Alternatively or additionally, the capability information may be obtained by the second UE from one or more other UEs, e.g., via PC5 signaling.

In accordance with an exemplary embodiment, the second UE may transmit a capability indication of the second UE and/or at least part of the capability information about the support of the multi-path communication to a network and/or another UE. In an embodiment, the capability indication of the second UE may indicate whether the second UE supports the multi-path communication.

In accordance with an exemplary embodiment, the capability indication of the second UE and/or the at least part of the capability information about the support of the multi-path communication may be transmitted to the network via one or more of: a message towards a serving base station of the second UE, and the message may be related to a capability of the second UE; RRC signaling towards the serving base station of the second UE; a measurement report of the second UE; and NAS signaling towards a core network entity. In an embodiment, the NAS signaling may be used to request the core network entity to indicate one or more cells whose serving base stations support the multi-path communication.

In accordance with an exemplary embodiment, the second UE may add a non-negative offset to a measurement result of one or more multi-path capable cells included in the measurement report of the second UE. Alternatively or additionally, the second UE may add a negative offset to a measurement result of one or more multi-path incapable cells included in the measurement report of the second UE.

In accordance with an exemplary embodiment, the capability indication of the second UE and/or the at least part of the capability information about the support of the multi-path communication may be transmitted to a serving base station of the second UE during RNA update.

In accordance with an exemplary embodiment, the capability indication of the second UE and/or the at least part of the capability information about the support of the multi-path communication may be transmitted to a serving base station of the second UE, when the serving base station of the second UE supports the multi-path communication.

In accordance with an exemplary embodiment, the second UE may be configured to be a multi-path capable UE which supports the multi-path communication.

In accordance with an exemplary embodiment, the second UE may prioritize one or more multi-path capable cells among one or more candidate cells for cell (re)selection and/or serving cell switching of the second UE. In an embodiment, for serving cell switching of the second UE, the multi-path capable cell may have a higher priority than the multi-path incapable cell to be selected as a target cell.

It can be appreciated that the first UE as described with respect to FIG. 3A may also be configured to perform the method 320 as described with respect to FIG. 3B, according to different application scenarios and service requirements. Similarly, it can be appreciated that the second UE as described with respect to FIG. 3B may also be configured to perform the method 310 as described with respect to FIG. 3A, according to different application scenarios and service requirements.

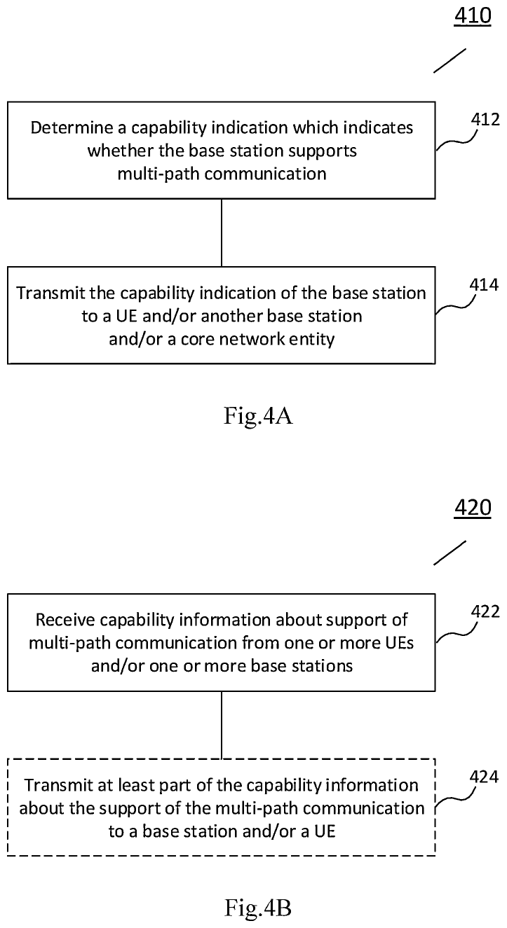

FIG. 4A is a flowchart illustrating a method 410 according to some embodiments of the present disclosure. The method 410 illustrated in FIG. 4A may be performed by a base station (e.g., a gNB, an AP, etc.) or an apparatus communicatively coupled to the base station. In accordance with an exemplary embodiment, the base station may be configured to support cellular coverage extension with D2D communication (e.g., V2X or SL communication, etc.). In an exemplary embodiment, the base station may be configured to communicate with a terminal device such as a UE, e.g. directly or via a relay.

According to the exemplary method 410 illustrated in FIG. 4A, the base station may determine a capability indication which indicates whether the base station supports multi-path communication, as shown in block 412. The multi-path communication may include at least relay path communication. In accordance with an exemplary embodiment, the base station may transmit the capability indication of the base station to a UE and/or another base station and/or a core network entity, as shown in block 414.

In accordance with an exemplary embodiment, the capability indication of the base station may be transmitted to the UE via one or more of: control signaling sent by the base station; and a message related to a capability of the UE.

In accordance with an exemplary embodiment, the base station may receive capability information about support of the multi-path communication from the core network entity and/or the UE and/or the another base station. In an embodiment, the capability information about the support of the multi-path communication may indicate one or more of: one or more multi-path capable cells whose serving base stations support the multi-path communication; one or more multi-path capable relay UEs whose serving cells are served by base stations supporting the multi-path communication; one or more multi-path capable base stations which support the multi-path communication; and one or more multi-path capable UEs which support the multi-path communication.

In accordance with an exemplary embodiment, the capability information about the support of the multi-path communication may be received by the base station from the UE via one or more of: a message related to a capability of the UE; RRC signaling; and a measurement report of the UE.

In accordance with an exemplary embodiment, a first non-negative offset may be added by the UE to a measurement result of one or more multi-path capable cells included in the measurement report of the UE. Alternatively or additionally, a first negative offset may be added by the UE to a measurement result of one or more multi-path incapable cells included in the measurement report of the UE. A serving base station of a multi-path incapable cell does not support the multi-path communication.

In accordance with an exemplary embodiment, a second non-negative offset may be added by the UE to a measurement result of one or more multi-path capable relay UEs included in the measurement report of the UE. Alternatively or additionally, a second negative offset may be added by the UE to a measurement result of one or more multi-path incapable relay UEs included in the measurement report of the UE. A serving cell of a multi-path incapable relay UE is served by a base station not supporting the multi-path communication.

In accordance with an exemplary embodiment, the capability information about the support of the multi-path communication may be received by the base station from the UE during RNA update. In accordance with another exemplary embodiment, the capability information about the support of the multi-path communication may be received by the base station from the UE, when the base station supports the multi-path communication.

In accordance with an exemplary embodiment, when the base station is configured to support the multi-path communication, the base station may transmit multi-path configuration information to a multi-path capable UE when the multi-path capable UE establishes or resumes a connection with the base station. In this case, there may exist one or more relay UEs whose serving cell is served by the base station, and the one or more relay UEs may have link quality to the multi-path capable UE equal to or higher than a threshold.

In accordance with an exemplary embodiment, the base station may receive, from the multi-path capable UE, link quality information related to the one or more relay UEs and/or the serving cell of the one or more relay UEs. In an embodiment, the link quality information may include: information about a measured RSRP/RSRQ and/or IDs of one or more relay UEs/cells selected by the multi-path capable UE, and/or an indication on whether the one or more selected relay UEs/cells have good enough link quality.

In accordance with an exemplary embodiment, for path switching of a multi-path capable UE, a multi-path capable cell may have a higher priority than a multi-path incapable cell to be selected as a target cell.

In accordance with an exemplary embodiment, for path switching of a multi-path capable UE, a multi-path capable relay UE may have a higher priority than a multi-path incapable relay UE to be selected as a target relay UE.

In accordance with an exemplary embodiment, the base station may prioritize one or more multi-path capable cells among one or more candidate cells for cell (re)selection and/or path switching of a UE. In an embodiment, among the one or more multi-path capable cells, compared to a first multi-path capable cell not serving a multi-path capable relay UE which is a candidate relay UE for relay UE (re)selection and/or path switching of the UE, a higher priority may be given to a second multi-path capable cell serving a multi-path capable relay UE which is also a candidate relay UE for the relay UE (re)selection and/or the path switching of the UE.

In accordance with an exemplary embodiment, the base station may prioritize one or more multi-path capable relay UEs among one or more candidate relay UEs for relay UE (re)selection and/or path switching of a UE. In an embodiment, among the one or more multi-path capable relay UEs, compared to a first multi-path capable relay UE served by a multi-path capable cell which is not a candidate cell for cell (re)selection and/or path switching of the UE, a higher priority may be given to a second multi-path capable relay UE served by a multi-path capable cell which is also a candidate cell for the cell (re)selection and/or the path switching of the UE.

In accordance with an exemplary embodiment, when a first remote UE is to switch from a first cell served by the base station to a second cell served by a target base station supporting the multi-path communication, the base station may transmit information about path switching of the first remote UE to the target base station. In an embodiment, the information about the path switching of the first remote UE may indicate one or more of: whether the first remote UE is a multi-path capable UE; whether the first remote UE is configured with multiple paths; configuration of each path of the first remote UE; a target cell selected for the first remote UE; and/or one or more target relay UEs selected for the first remote UE.

In accordance with an exemplary embodiment, when multiple paths are to be configured by the target base station for the first remote UE after path switching, the base station may receive multi-path configuration information of the first remote UE from the target base station. In an embodiment, the base station may forward the multi-path configuration information to the first remote UE.

In accordance with an exemplary embodiment, when a second remote UE is to switch from a third cell served by a source base station to a fourth cell served by the base station supporting the multi-path communication, the base station may receive information about path switching of the second remote UE from the source base station.

In accordance with an exemplary embodiment, the base station may determine whether to configure multiple paths for the second remote UE after the path switching, according to the information about the path switching of the second remote UE. In an embodiment, the information about the path switching of the second remote UE may indicate one or more of: whether the second remote UE is a multi-path capable UE; whether the second remote UE is configured with multiple paths; configuration of each path of the second remote UE; a target cell selected for the second remote UE; and/or one or more target relay UEs selected for the second remote UE.

In accordance with an exemplary embodiment, when the base station determines to configure the multiple paths for the second remote UE after the path switching, the base station may determine multi-path configuration information of the second remote UE and transmit the multi-path configuration information to the second remote UE via the source base station.

FIG. 4B is a flowchart illustrating a method 420 according to some embodiments of the present disclosure. The method 420 illustrated in FIG. 4B may be performed by a core network entity (e.g., an AMF, etc.) or an apparatus communicatively coupled to the core network entity. In accordance with an exemplary embodiment, the core network entity may be configured to provision services to a terminal device such as a UE via a RAN node such as a base station.

According to the exemplary method 420 illustrated in FIG. 4B, the core network entity may receive capability information about support of multi-path communication from one or more UEs and/or one or more base stations, as shown in block 422. The multi-path communication may include at least relay path communication. In accordance with an exemplary embodiment, the capability information may indicate one or more of: one or more multi-path capable cells whose serving base stations support the multi-path communication; one or more multi-path capable base stations which support the multi-path communication; one or more multi-path capable UEs which support the multi-path communication; and one or more multi-path capable relay UEs whose serving cells are served by base stations supporting the multi-path communication.

In accordance with an exemplary embodiment, the capability information may be received by the core network entity via one or more of: one or more capability indications indicating whether the one or more UEs and/or the one or more base stations support the multi-path communication; and NAS signaling from the one or more UEs. In an embodiment, the NAS signaling may be used to request the core network entity to indicate one or more cells whose serving base stations support the multi-path communication.

In accordance with an exemplary embodiment, the core network entity may optionally transmit at least part of the capability information about the support of the multi-path communication to a base station and/or a UE, as shown in block 424.

The various blocks shown in FIGS. 3A-3B and FIGS. 4A-4B may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

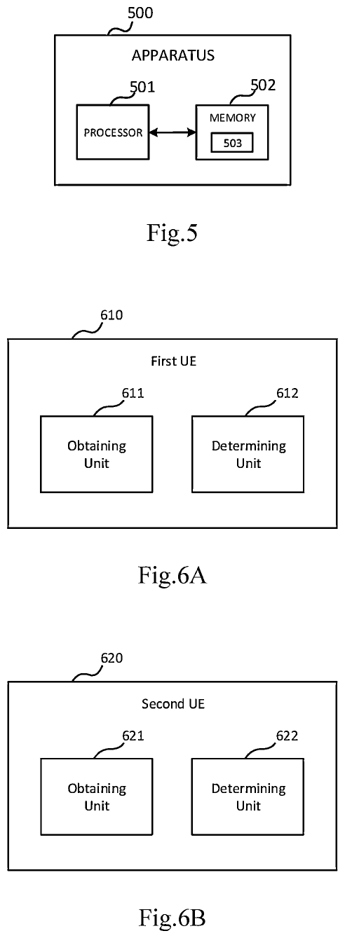

FIG. 5 is a block diagram illustrating an apparatus 500 according to various embodiments of the present disclosure. As shown in FIG. 5, the apparatus 500 may comprise one or more processors such as processor 501 and one or more memories such as memory 502 storing computer program codes 503. The memory 502 may be non-transitory machine/processor/computer readable storage medium. In accordance with some exemplary embodiments, the apparatus 500 may be implemented as an integrated circuit chip or module that can be plugged or installed into a first UE as described with respect to FIG. 3A, a second UE as described with respect to FIG. 3B, a base station as described with respect to FIG. 4A, or a core network entity as described with respect to FIG. 4B. In such cases, the apparatus 500 may be implemented as a first UE as described with respect to FIG. 3A, a second UE as described with respect to FIG. 3B, a base station as described with respect to FIG. 4A, or a core network entity as described with respect to FIG. 4B.

In some implementations, the one or more memories 502 and the computer program codes 503 may be configured to, with the one or more processors 501, cause the apparatus 500 at least to perform any operation of the method as described in connection with FIG. 3A. In other implementations, the one or more memories 502 and the computer program codes 503 may be configured to, with the one or more processors 501, cause the apparatus 500 at least to perform any operation of the method as described in connection with FIG. 3B. In other implementations, the one or more memories 502 and the computer program codes 503 may be configured to, with the one or more processors 501, cause the apparatus 500 at least to perform any operation of the method as described in connection with FIG. 4A. In other implementations, the one or more memories 502 and the computer program codes 503 may be configured to, with the one or more processors 501, cause the apparatus 500 at least to perform any operation of the method as described in connection with FIG. 4B. Alternatively or additionally, the one or more memories 502 and the computer program codes 503 may be configured to, with the one or more processors 501, cause the apparatus 500 at least to perform more or less operations to implement the proposed methods according to the exemplary embodiments of the present disclosure.

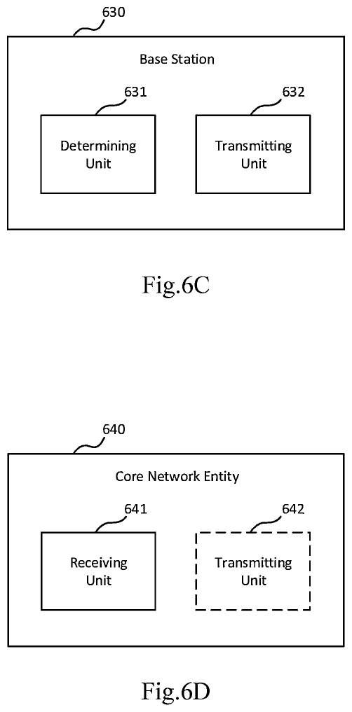

FIG. 6A is a block diagram illustrating an apparatus 610 according to some embodiments of the present disclosure. As shown in FIG. 6A, the apparatus 610 may comprise an obtaining unit 611 and a determining unit 612. In an exemplary embodiment, the apparatus 610 may be implemented in a first UE. The obtaining unit 611 may be operable to carry out the operation in block 312, and the determining unit 612 may be operable to carry out the operation in block 314. Optionally, the obtaining unit 611 and/or the determining unit 612 may be operable to carry out more or less operations to implement the proposed methods according to the exemplary embodiments of the present disclosure.

FIG. 6B is a block diagram illustrating an apparatus 620 according to some embodiments of the present disclosure. As shown in FIG. 6B, the apparatus 620 may comprise an obtaining unit 621 and a determining unit 622. In an exemplary embodiment, the apparatus 620 may be implemented in a second UE. The obtaining unit 621 may be operable to carry out the operation in block 322, and the determining unit 622 may be operable to carry out the operation in block 324. Optionally, the obtaining unit 621 and/or the determining unit 622 may be operable to carry out more or less operations to implement the proposed methods according to the exemplary embodiments of the present disclosure.

FIG. 6C is a block diagram illustrating an apparatus 630 according to some embodiments of the present disclosure. As shown in FIG. 6C, the apparatus 630 may comprise a determining unit 631 and a transmitting unit 632. In an exemplary embodiment, the apparatus 630 may be implemented in a base station (e.g., a gNB, etc.). The determining unit 631 may be operable to carry out the operation in block 412, and the transmitting unit 632 may be operable to carry out the operation in block 414. Optionally, the determining unit 631 and/or the transmitting unit 632 may be operable to carry out more or less operations to implement the proposed methods according to the exemplary embodiments of the present disclosure.

FIG. 6D is a block diagram illustrating an apparatus 640 according to some embodiments of the present disclosure. As shown in FIG. 6D, the apparatus 640 may comprise a receiving unit 641 and optionally a transmitting unit 642. In an exemplary embodiment, the apparatus 640 may be implemented in a core network entity (e.g., an AMF, etc.). The receiving unit 641 may be operable to carry out the operation in block 422, and the transmitting unit 642 may be operable to carry out the operation in block 424. Optionally, the receiving unit 641 and/or the transmitting unit 642 may be operable to carry out more or less operations to implement the proposed methods according to the exemplary embodiments of the present disclosure.

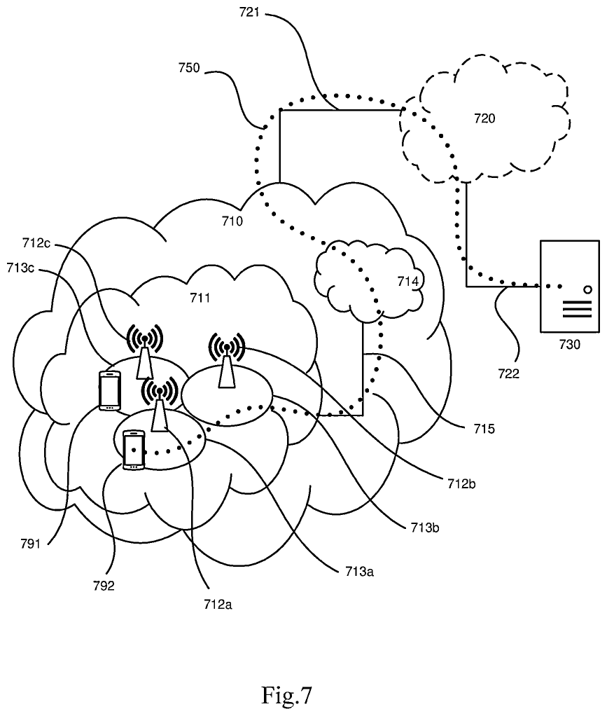

FIG. 7 is a block diagram illustrating a telecommunication network connected via an intermediate network to a host computer in accordance with some embodiments of the present disclosure.

With reference to FIG. 7, in accordance with an embodiment, a communication system includes a telecommunication network 710, such as a 3GPP-type cellular network, which comprises an access network 711, such as a radio access network, and a core network 714. The access network 711 comprises a plurality of base stations 712a, 712b, 712c, such as NBs, eNBs, gNBs or other types of wireless access points, each defining a corresponding coverage area 713a, 713b, 713c. Each base station 712a, 712b, 712c is connectable to the core network 714 over a wired or wireless connection 715. A first UE 791 located in a coverage area 713c is configured to wirelessly connect to, or be paged by, the corresponding base station 712c. A second UE 792 in a coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

The telecommunication network 710 is itself connected to a host computer 730, which may be embodied in the hardware and/or software of a standalone server, a cloud-implemented server, a distributed server or as processing resources in a server farm. The host computer 730 may be under the ownership or control of a service provider, or may be operated by the service provider or on behalf of the service provider. Connections 721 and 722 between the telecommunication network 710 and the host computer 730 may extend directly from the core network 714 to the host computer 730 or may go via an optional intermediate network 720. An intermediate network 720 may be one of, or a combination of more than one of, a public, private or hosted network; the intermediate network 720, if any, may be a backbone network or the Internet; in particular, the intermediate network 720 may comprise two or more sub-networks (not shown).

The communication system of FIG. 7 as a whole enables connectivity between the connected UEs 791, 792 and the host computer 730. The connectivity may be described as an over-the-top (OTT) connection 750. The host computer 730 and the connected UEs 791, 792 are configured to communicate data and/or signaling via the OTT connection 750, using the access network 711, the core network 714, any intermediate network 720 and possible further infrastructure (not shown) as intermediaries. The OTT connection 750 may be transparent in the sense that the participating communication devices through which the OTT connection 750 passes are unaware of routing of uplink and downlink communications. For example, the base station 712 may not or need not be informed about the past routing of an incoming downlink communication with data originating from the host computer 730 to be forwarded (e.g., handed over) to a connected UE 791. Similarly, the base station 712 need not be aware of the future routing of an outgoing uplink communication originating from the UE 791 towards the host computer 730.

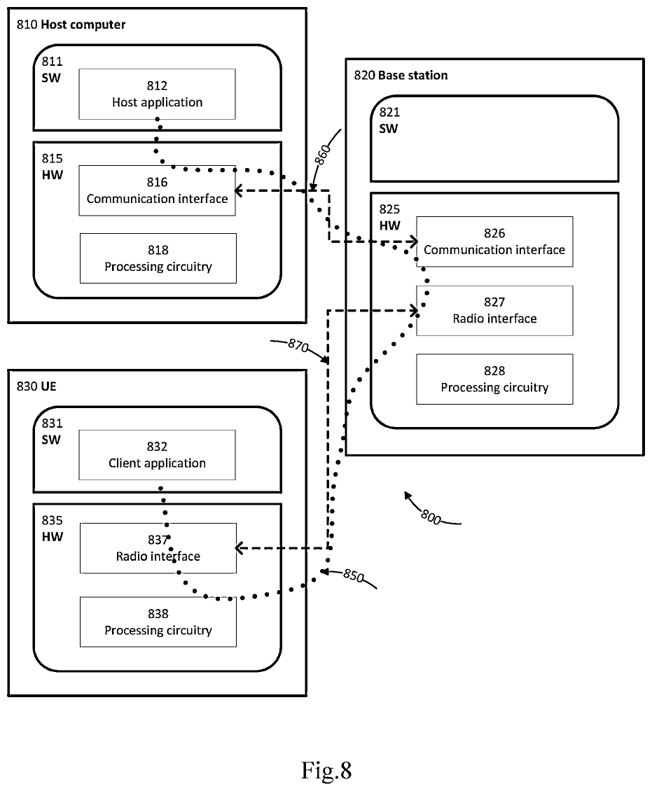

FIG. 8 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 8. In a communication system 800, a host computer 810 comprises hardware 815 including a communication interface 816 configured to set up and maintain a wired or wireless connection with an interface of a different communication device of the communication system 800. The host computer 810 further comprises a processing circuitry 818, which may have storage and/or processing capabilities. In particular, the processing circuitry 818 may comprise one or more programmable processors, application-specific integrated circuits, field programmable gate arrays or combinations of these (not shown) adapted to execute instructions. The host computer 810 further comprises software 811, which is stored in or accessible by the host computer 810 and executable by the processing circuitry 818. The software 811 includes a host application 812. The host application 812 may be operable to provide a service to a remote user, such as UE 830 connecting via an OTT connection 850 terminating at the UE 830 and the host computer 810. In providing the service to the remote user, the host application 812 may provide user data which is transmitted using the OTT connection 850.

The communication system 800 further includes a base station 820 provided in a telecommunication system and comprising hardware 825 enabling it to communicate with the host computer 810 and with the UE 830. The hardware 825 may include a communication interface 826 for setting up and maintaining a wired or wireless connection with an interface of a different communication device of the communication system 800, as well as a radio interface 827 for setting up and maintaining at least a wireless connection 870 with the UE 830 located in a coverage area (not shown in FIG. 8) served by the base station 820. The communication interface 826 may be configured to facilitate a connection 860 to the host computer 810. The connection 860 may be direct or it may pass through a core network (not shown in FIG. 8) of the telecommunication system and/or through one or more intermediate networks outside the telecommunication system. In the embodiment shown, the hardware 825 of the base station 820 further includes a processing circuitry 828, which may comprise one or more programmable processors, application-specific integrated circuits, field programmable gate arrays or combinations of these (not shown) adapted to execute instructions. The base station 820 further has software 821 stored internally or accessible via an external connection.

The communication system 800 further includes the UE 830 already referred to. Its hardware 835 may include a radio interface 837 configured to set up and maintain a wireless connection 870 with a base station serving a coverage area in which the UE 830 is currently located. The hardware 835 of the UE 830 further includes a processing circuitry 838, which may comprise one or more programmable processors, application-specific integrated circuits, field programmable gate arrays or combinations of these (not shown) adapted to execute instructions. The UE 830 further comprises software 831, which is stored in or accessible by the UE 830 and executable by the processing circuitry 838. The software 831 includes a client application 832. The client application 832 may be operable to provide a service to a human or non-human user via the UE 830, with the support of the host computer 810. In the host computer 810, an executing host application 812 may communicate with the executing client application 832 via the OTT connection 850 terminating at the UE 830 and the host computer 810. In providing the service to the user, the client application 832 may receive request data from the host application 812 and provide user data in response to the request data. The OTT connection 850 may transfer both the request data and the user data. The client application 832 may interact with the user to generate the user data that it provides.

It is noted that the host computer 810, the base station 820 and the UE 830 illustrated in FIG. 8 may be similar or identical to the host computer 730, one of base stations 712a, 712b, 712c and one of UEs 791, 792 of FIG. 7, respectively. This is to say, the inner workings of these entities may be as shown in FIG. 8 and independently, the surrounding network topology may be that of FIG. 7.

In FIG. 8, the OTT connection 850 has been drawn abstractly to illustrate the communication between the host computer 810 and the UE 830 via the base station 820, without explicit reference to any intermediary devices and the precise routing of messages via these devices. Network infrastructure may determine the routing, which it may be configured to hide from the UE 830 or from the service provider operating the host computer 810, or both. While the OTT connection 850 is active, the network infrastructure may further take decisions by which it dynamically changes the routing (e.g., on the basis of load balancing consideration or reconfiguration of the network).

Wireless connection 870 between the UE 830 and the base station 820 is in accordance with the teachings of the embodiments described throughout this disclosure. One or more of the various embodiments improve the performance of OTT services provided to the UE 830 using the OTT connection 850, in which the wireless connection 870 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 850 between the host computer 810 and the UE 830, in response to variations in the measurement results. The measurement procedure and/or the network functionality for reconfiguring the OTT connection 850 may be implemented in software 811 and hardware 815 of the host computer 810 or in software 831 and hardware 835 of the UE 830, or both. In embodiments, sensors (not shown) may be deployed in or in association with communication devices through which the OTT connection 850 passes; the sensors may participate in the measurement procedure by supplying values of the monitored quantities exemplified above, or supplying values of other physical quantities from which the software 811, 831 may compute or estimate the monitored quantities. The reconfiguring of the OTT connection 850 may include message format, retransmission settings, preferred routing etc.; the reconfiguring need not affect the base station 820, and it may be unknown or imperceptible to the base station 820. Such procedures and functionalities may be known and practiced in the art. In certain embodiments, measurements may involve proprietary UE signaling facilitating the host computer 810's measurements of throughput, propagation times, latency and the like. The measurements may be implemented in that the software 811 and 831 causes messages to be transmitted, in particular empty or ‘dummy’ messages, using the OTT connection 850 while it monitors propagation times, errors etc.

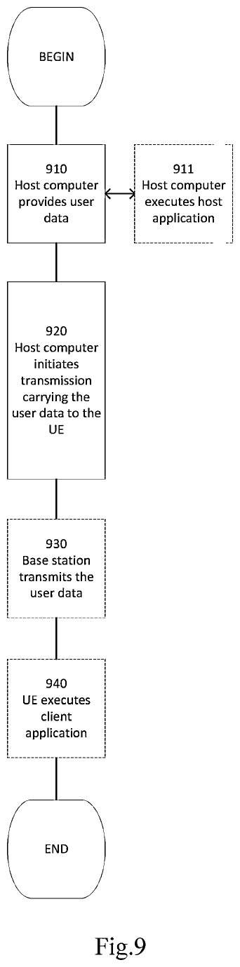

FIG. 9 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 9 will be included in this section. In step 910, the host computer provides user data. In substep 911 (which may be optional) of step 910, the host computer provides the user data by executing a host application. In step 920, the host computer initiates a transmission carrying the user data to the UE. In step 930 (which may be optional), the base station transmits to the UE the user data which was carried in the transmission that the host computer initiated, in accordance with the teachings of the embodiments described throughout this disclosure. In step 940 (which may also be optional), the UE executes a client application associated with the host application executed by the host computer.

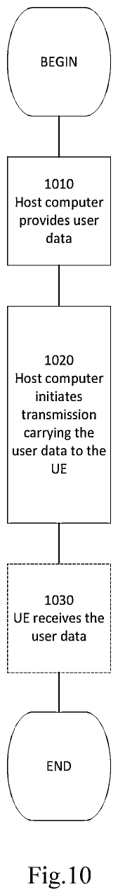

FIG. 10 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 10 will be included in this section. In step 1010 of the method, the host computer provides user data. In an optional substep (not shown) the host computer provides the user data by executing a host application. In step 1020, the host computer initiates a transmission carrying the user data to the UE. The transmission may pass via the base station, in accordance with the teachings of the embodiments described throughout this disclosure. In step 1030 (which may be optional), the UE receives the user data carried in the transmission.

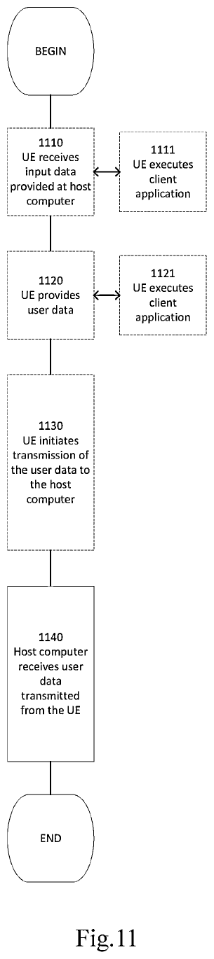

FIG. 11 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

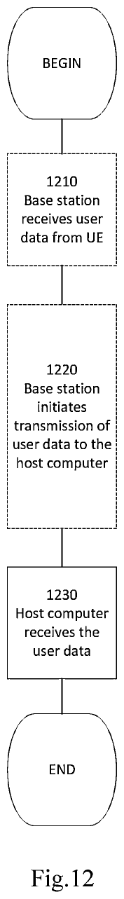

FIG. 12 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the exemplary method 410 as described with respect to FIG. 4A.

According to some exemplary embodiments, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the exemplary method 410 as described with respect to FIG. 4A.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the exemplary method 310 as described with respect to FIG. 3A, or any step of the exemplary method 320 as described with respect to FIG. 3B.

According to some exemplary embodiments, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the exemplary method 310 as described with respect to FIG. 3A, or any step of the exemplary method 320 as described with respect to FIG. 3B.

According to some exemplary embodiments, there is provided a method implemented in a communication system which may include a host computer, a base station and a UE. The method may comprise, at the host computer, receiving user data transmitted to the base station from the UE which may perform any step of the exemplary method 310 as described with respect to FIG. 3A, or any step of the exemplary method 320 as described with respect to FIG. 3B.

According to some exemplary embodiments, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the exemplary method 310 as described with respect to FIG. 3A, or any step of the exemplary method 320 as described with respect to FIG. 3B.

According to some exemplary embodiments, there is provided a method implemented in a communication system which may include a host computer, a base station and a UE. The method may comprise, at the host computer, receiving, from the base station, user data originating from a transmission which the base station has received from the UE. The base station may perform any step of the exemplary method 410 as described with respect to FIG. 4A.

According to some exemplary embodiments, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the exemplary method 410 as described with respect to FIG. 4A.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method performed by a first user equipment, UE, comprising:
obtaining capability information about support of multi-path communication, wherein the multi-path communication includes at least relay path communication; and
determining whether a cell is a multi-path capable cell or a multi-path incapable cell, and/or whether a second UE is a multi-path capable relay UE or a multi-path incapable relay UE, according to the capability information, wherein a serving base station of the multi-path capable cell supports the multi-path communication, a serving base station of the multi-path incapable cell does not support the multi-path communication, a serving cell of the multi-path capable relay UE is served by a base station supporting the multi-path communication, and a serving cell of the multi-path incapable relay UE is served by a base station not supporting the multi-path communication.

2. The method according to claim 1, wherein the capability information indicates one or more of:
one or more multi-path capable cells;
one or more multi-path capable relay UEs;
one or more multi-path capable base stations which support the multi-path communication; and
one or more multi-path capable UEs which support the multi-path communication.

3.-4. (canceled)

5. The method according to claim 1, further comprising:
transmitting a capability indication of the first UE and/or at least part of the capability information about the support of the multi-path communication to a network and/or another UE.

6. The method according to claim 5, wherein the capability indication of the first UE indicates whether the first UE supports the multi-path communication.

7. The method according to claim 5, wherein the capability indication of the first UE and/or the at least part of the capability information about the support of the multi-path communication are transmitted to the network via one or more of:
a message towards a serving base station of the first UE, wherein the message is related to a capability of the first UE;
radio resource control, RRC, signaling towards the serving base station of the first UE;
a measurement report of the first UE; and
NAS signaling towards a core network entity.

8. The method according to claim 7, wherein the NAS signaling is used to request the core network entity to indicate one or more cells whose serving base stations support the multi-path communication.

9. The method according to claim 7, further comprising:
adding a first non-negative offset to a measurement result of one or more multi-path capable cells included in the measurement report of the first UE; and/or
adding a first negative offset to a measurement result of one or more multi-path incapable cells included in the measurement report of the first UE.

10. The method according to claim 7, further comprising:
adding a second non-negative offset to a measurement result of one or more multi-path capable relay UEs included in the measurement report of the first UE; and/or
adding a second negative offset to a measurement result of one or more multi-path incapable relay UEs included in the measurement report of the first UE.

11. The method according to claim 5, wherein the capability indication of the first UE and/or the at least part of the capability information about the support of the multi-path communication are transmitted to a serving base station of the first UE during radio access network notification area, RNA, update.

12. The method according to claim 5, wherein the capability indication of the first UE and/or the at least part of the capability information about the support of the multi-path communication are transmitted to a serving base station of the first UE, when the serving base station of the first UE supports the multi-path communication.

13.-14. (canceled)

15. The method according to claim 1, wherein the first UE is configured to be a multi-path capable UE which supports the multi-path communication, and prioritizing one or more multi-path capable cells among one or more candidate cells for cell (re)selection and/or path switching of the first UE, wherein among the one or more multi-path capable cells, compared to a first multi-path capable cell not serving a multi-path capable relay UE which is a candidate relay UE for relay UE (re)selection and/or path switching of the first UE, a higher priority is given to a second multi-path capable cell serving a multi-path capable relay UE which is also a candidate relay UE for the relay UE (re)selection and/or the path switching of the first UE.

16. (canceled)

17. The method according to claim 1, wherein the first UE is configured to be a multi-path capable UE which supports the multi-path communication, and prioritizing one or more multi-path capable relay UEs among one or more candidate relay UEs for relay UE (re)selection and/or path switching of the first UE, wherein among the one or more multi-path capable relay UEs, compared to a first multi-path capable relay UE served by a multi-path capable cell which is not a candidate cell for cell (re)selection and/or path switching of the first UE, a higher priority is given to a second multi-path capable relay UE served by a multi-path capable cell which is also a candidate cell for the cell (re)selection and/or the path switching of the first UE.

18.-25. (canceled)

26. A method performed by a second user equipment, UE, comprising:
obtaining capability information about support of multi-path communication, wherein the multi-path communication includes at least relay path communication; and
determining whether a cell is a multi-path capable cell or a multi-path incapable cell, and/or whether a first UE is a multi-path capable UE or a multi-path incapable UE, according to the capability information, wherein a serving base station of the multi-path capable cell supports the multi-path communication, a serving base station of the multi-path incapable cell does not support the multi-path communication, the multi-path capable UE supports the multi-path communication, and the multi-path incapable UE does not support the multi-path communication.

27.-42. (canceled)

43. A method performed by a base station, comprising:
determining a capability indication which indicates whether the base station supports multi-path communication, wherein the multi-path communication includes at least relay path communication; and
transmitting the capability indication of the base station to a user equipment, UE, and/or another base station and/or a core network entity.

44. (canceled)

45. The method according to claim 43, further comprising:
receiving capability information about support of the multi-path communication from the core network entity and/or the UE and/or the another base station, wherein the capability information about the support of the multi-path communication indicates one or more of:
one or more multi-path capable cells whose serving base stations support the multi-path communication;
one or more multi-path capable relay UEs whose serving cells are served by base stations supporting the multi-path communication;
one or more multi-path capable base stations which support the multi-path communication; and
one or more multi-path capable UEs which support the multi-path communication.

46.-47. (canceled)

48. The method according to claim 45, wherein the capability information about the support of the multi-path communication is received by the base station from the UE via one or more of:
a message related to a capability of the UE;
radio resource control, RRC, signaling; and
a measurement report of the UE, and
wherein a first negative offset is added by the UE to a measurement result of one or more multi-path incapable cells included in the measurement report of the UE, and wherein a serving base station of a multi-path incapable cell does not support the multi-path communication.

49. The method according to claim 45, wherein the capability information about the support of the multi-path communication is received by the base station from the UE via one or more of:
a message related to a capability of the UE;
radio resource control, RRC, signaling; and
a measurement report of the UE, and
wherein a second non-negative offset is added by the UE to a measurement result of one or more multi-path capable relay UEs included in the measurement report of the UE.

50.-69. (canceled)

70. A method performed by a core network entity, comprising:
receiving capability information about support of multi-path communication from one or more user equipments, UEs, and/or one or more base stations, wherein the multi-path communication includes at least relay path communication, and the capability information indicates one or more of:
one or more multi-path capable cells whose serving base stations support the multi-path communication;
one or more multi-path capable base stations which support the multi-path communication;
one or more multi-path capable UEs which support the multi-path communication; and
one or more multi-path capable relay UEs whose serving cells are served by base stations supporting the multi-path communication.

71. The method according to claim 70, wherein the capability information is received by the core network entity via one or more of:
one or more capability indications indicating whether the one or more UEs and/or the one or more base stations support the multi-path communication; and
non-access stratum, NAS, signaling from the one or more UEs.

72. The method according to claim 71, wherein the NAS signaling is used to request the core network entity to indicate one or more cells whose serving base stations support the multi-path communication.

73.-76. (canceled)
